(19) United States
(12) Patent Application Publication
(10) Pub. No.: US 2024/0400274 A1
(43) Pub. Date: Dec. 5, 2024

(54) BEVERAGE CONTAINER

(71) Applicant: STARFLOW GMBH, Stans (CH)

(72) Inventor: Dmitry GANZHA, Wien (AT)

(73) Assignee: STARFLOW GMBH, Stans (CH)

(21) Appl. No.: 18/573,434

(22) PCT Filed: Jun. 10, 2022
(86) PCT No.: PCT/EP2022/065815

§ 371 Date: Jul. 22, 2024

(30) Foreign Application Priority Data
Jun. 24, 2021 (EP) 21181369.6
Oct. 26, 2021 (EP) 21204634.6

(51) Int. Cl. B65D 51/24; B65D 43/16; B65D 43/22

(52) U.S. Cl. CPC B65D 51/248; B65D 43/163; B65D 43/22; B65D 51/242; B65D 2251/1058; B65D 2543/00092; B65D 2543/00296; G01F 1/10; G01F 23/292; G01F 23/296

(57) ABSTRACT

A beverage container (2) is disclosed which has:—a cup (4) with a wall (6) which delimits a receiving space (8) open on an upper side (O) of the cup (4) for liquid, and—a cover (10) which is arranged removably on the upper side (O) of the cup (4) in such a manner that it closes a receiving space opening (12) of the receiving space (8) in a fluid-tight manner, wherein—a sensor unit (14) is arranged in the cover (10) for detecting an amount of liquid removed from the cup (4) by a user,—the cover (10) has a light element (40) which is configured to light up in different colors depending on the amount of liquid removed by the user, and—the cover (10) further has a wireless communication unit (20) which is configured to communicate with a mobile terminal device of the user in such a manner that the amount of liquid removed by the user is detected, the cover further has a wireless communication unit configured to form a data connection with a mobile terminal device of the user and to transmit the detected amount of liquid to the mobile terminal device of the user for evaluation.

The invention relates to a beverage container.

Beverage containers, particularly reusable beverage containers, are becoming increasingly popular.

Nowadays, such beverage containers are available and can be used in many designs, in many colors and also personalized. They also make it possible to take both hot drinks, such as coffee or tea, and cold drinks, such as water or soft drinks, spill-proof with you and consume them almost anywhere.

Typically, a beverage container of this type has a cup with a wall that defines an interior space. The interior space serves as a receptacle for the beverage. Further, known beverage containers have a cover which is removably arranged on an opening of the cup.

In the age of fitness health apps and sports tracking, there is an increasing need to collect fitness or “health” data in order to provide users of such apps with a detailed evaluation of their lifestyle, particularly their diet. In addition to vital signs such as pulse, blood pressure or oxygen saturation, fitness data can also include the amount of fluid consumed over a specific time interval.

Particularly with regard to the latter aspect, it is often necessary for the user to manually enter the amount of liquid consumed before the applications determine whether enough or too little liquid has been consumed.

Based on this, the object of the invention is to provide a beverage container which enables a user to easily and particularly automatically record the amount of liquid consumed.

The object is solved according to the invention by a beverage container with the features of claim 1. Advantageous embodiments, further embodiments and variants are the subject matter of the subclaims.

Specifically, the object is solved by a beverage container which has a cup and a cover. The cup has a wall that delimits an open receiving space for liquid on one upper side of the cup.

The cover is removably arranged on the upper side of the cup in such a manner that it closes a receiving opening of the receiving space in a fluid-tight manner so that no liquid can escape when the filled beverage container is transported or falls over.

For the purposes of this application, the term “liquid” can be understood to mean beverages in general and, for example, but not restrictively, the hot or cold beverages mentioned at the beginning.

According to the invention, a sensor unit is arranged in the cover. The sensor unit is used to detect the amount of liquid removed from the cup by a user. In other words, the sensor unit detects the amount of liquid drunk by the user.

Further, the cover has a light element that is configured to light up in different colors depending on the amount of liquid removed by the user. This is particularly useful for showing the user in a simple manner whether a specified amount of liquid has already been drunk. This means that the light element can light up red, for example, if a specified amount of liquid has not yet been removed, i.e. drunk, and light up green, for example, when the specified amount of liquid has been reached. Further, other color and/or light combinations are also conceivable.

Furthermore, according to the invention, the beverage container has a wireless communication unit which is configured to form a data connection with a mobile terminal device of the user and to transmit the detected quantity of liquid to the user's mobile terminal device for evaluation.

The mobile terminal device can generally be understood as an electronic communication device or a (portable) computer. Specifically, the mobile terminal device is a cell phone (smartphone), a tablet, a smart watch or a personal digital assistant (PDA). The data connection can, for example, be a known short-range data connection such as Bluetooth. This ensures the greatest possible compatibility between the beverage container and users' mobile terminal devices. Alternatively, the mobile terminal device can also be an analysis device of a doctor who can use the recorded values for a diagnosis in this context. It is further conceivable to use several mobile terminal devices to record vital values. For example, headphones connected wirelessly or wired to the user's cell phone can be used to record the user's body temperature and transmit this information to the aforementioned health app for further processing.

Further, the light element can alternatively or additionally visualize the established data connection, i.e. when the beverage container has successfully connected to the mobile terminal device. For this purpose, the light element can light up in another color, for example blue.

The evaluation can be carried out by a fitness or health app, for example, which relates the recorded value to a recommended amount of fluid and informs the user accordingly whether and/or when they have drunk enough. The user therefore always knows how much liquid they have already consumed per unit of time, for example per day, and how much more they should consume if necessary. Further, the evaluation can also be designed in such a manner that the user is reminded to drink by a notification. This recording and evaluation is fully automated as the user drinks from the beverage container, as the amount of liquid drunk flows through the sensor unit beforehand. This means that the user does not have to record or enter the amount drunk manually.

In one embodiment, the sensor unit is further configured to detect organic contaminants, particularly bacteria and/or viruses, and/or at least one vital value that can be derived from the user's saliva. In this context, the wireless communication unit is also configured to transmit this recorded data to the user's mobile terminal device for evaluation.

The idea behind the detection of such organic pollutants is to warn the user if they have an increased level of pollutants (e.g. an increased number of bacteria and/or viruses) in their saliva. This can be a sign of an impending illness and/or infection, for example. Further, the user's blood sugar level, for example, can be determined. The user can be evaluated and warned, for example, by means of and through the aforementioned fitness health app, which is stored on the user's mobile terminal device.

However, the at least one vital value can be, for example, the (blood) sugar value, the recording and evaluation of which is particularly relevant for diabetics. However, other similarly derivable vital values can also be recorded.

The advantage of this design therefore lies in the extended recording of parameters that allow the user to easily obtain information about their state of health and/or diet.

In a further embodiment, the cup and/or the cover has an electric energy store. The electric energy store, which is preferably designed as a rechargeable battery, is used to supply the sensor unit and/or the wireless communication unit with electric energy.

Alternatively or additionally, the light element can also be used to indicate a charge status, so that it lights up green, for example, when the charge status of the electric energy store is still sufficient. If the light element lights up red, for example, this indicates a low charge level and the beverage container should be recharged.

Alternatively or additionally, the state of charge of the electric energy store can also be transmitted to the user's mobile terminal device by the wireless communication unit such that the user can check the state of charge of the electric energy store on the mobile terminal device.

In accordance with a further embodiment, the cup and/or the cover has a charging element for wired and/or wireless charging of the electric energy store. The term “wireless charging” can be understood to mean inductive charging, for example. The charging element can be arranged in the base of the cup, for example, so that the beverage container is placed on an inductive charging station for charging, similar to the inductive charging of today's smartphones. If the charging element is arranged in the cover, it can, for example, be removed from the cup (e.g. unscrewed) to charge the energy storage device and placed on an inductive charging station in a manner analogous to the example described above.

Alternatively or additionally, the charging element is designed for cable-connected charging of the electric energy store.

This makes it easy to recharge the electric energy store.

In one embodiment, the sensor unit is arranged in the cover. In a further development, the cover has a tubular mouthpiece in which the sensor unit is arranged. The mouthpiece makes it easier to drink from the beverage container and to record the amount of liquid drunk.

In one embodiment, the light element is designed as a light ring, particularly as a LED light ring, which is arranged on an upper side of the cover. Here, the light ring is arranged on an exterior side of the cover, in other words, completely visible “from the outside” on the upper side of the cover. This ensures that the light element that is illuminated, and particularly the color in which the light element is illuminated, is easily and quickly visible.

Furthermore, in another embodiment, the cover has a cover flap and a folding mechanism. In its simplest form, the folding mechanism is a hinge. The cover flap is pivoted on the folding mechanism from a closed position to an open position and vice versa. By “flipping up” the cover flap, for example, the mouthpiece becomes accessible so that the user can drink through it. Furthermore, the mouthpiece is protected from contamination by the folded-down cover flap, e.g. when transporting the beverage container.

In one embodiment, the cover has a locking unit for locking the folding mechanism, which has a latching element for locking the folding mechanism and an unlocking element for unlocking the latching element. The latching element is arranged on the cover flap and forms a latching connection with a corresponding element on the cover to lock the cover. By means of the unlocking element, this latching connection can be released to open the cover flap.

In a further development, the unlocking element is held in a locking position by means of at least one pair of magnets. Here, the term “locking position” can be understood to mean a position or position of the unlocking element in which the cover flap can be locked by the aforementioned latching elements. For this purpose, the first magnet of the at least one pair of magnets is arranged in the unlocking element and the second magnet of the at least one pair of magnets is arranged on or in the cover. The application of magnetic force ensures reliable positioning of the unlocking element, enabling reliable latching and thus locking of the cover. Further, the unlocking element has a threshold safety device. For the purposes of this application, the term “threshold safety device” can be understood to mean that in order to unlock the cover flap, the unlocking element must be moved either successively or simultaneously in the direction of two axes relative to the beverage container. For example, the unlocking element must be moved “diagonally upwards” (i.e. along a longitudinal and a transverse axis of the container) in order to release the latching connection between the cover flap and the cover. This prevents the cover from opening, for example, if the unlocking element is accidentally “pressed”. The threshold safety device described above ensures that simply “pressing” the unlocking element is not sufficient to release the lock. Instead, the unlocking element must be moved in a further direction, i.e. along a further axis relative to the beverage container.

In accordance with a further development, the folding mechanism and the communication unit are designed to form the data connection with the user's mobile terminal device when the cover flap is swiveled from the closed position to the open position. On the one hand, this means that the data connection is only established if it is also to transmit recorded values and, on the other hand, the service life per charge of the electric energy store is extended, as the data connection is not permanently active.

In one embodiment, the sensor unit has a turbine sensor or a laser sensor or an ultrasonic sensor for detecting the amount of liquid removed. In a turbine sensor, the liquid flows through a turbine-like component that is rotatably mounted. As the liquid flows through, the turbine-like component is set in rotation and activates a counter that determines the amount of liquid that has flowed through the sensory system based on the number of revolutions. With the laser sensor, the current fill level in the cup is determined after liquid has been dispensed in order to determine the amount of liquid dispensed. These types of flow sensors for detecting liquid quantities are available on the open market in different variants and designs, which simplifies the design and configuration of the beverage container.

In order to reuse the beverage container and to make it easier to transport, the cup and/or the cover has a plastic material or the cup and/or the cover is formed from a plastic material. This can be a plastic commonly used in the beverage industry and especially in the production of beverage containers. The use of plastic also means that the drinks container is better protected against damage (e.g. from impact on the ground) than fragile materials such as porcelain.

To make the beverage container furthermore easier and more handy to transport, the cup has a volume with a value in the area of 0.2 l to 1.5 l, preferably in the area of 0.5 l to 1 l and particularly with a value of 0.75 l.

In accordance with one embodiment, a carrying loop is arranged on the cover. The carrying strap makes it easy to grip and carry the drinks container and can be customized by the user, particularly in terms of color. Alternatively, the carrying loop is reversible, i.e. removable from the cover and can therefore be replaced by other carrying loops of a different color, for example.

An exemplary embodiment of the invention is explained in more detail below with reference to the figures. These show a partially simplified representation:

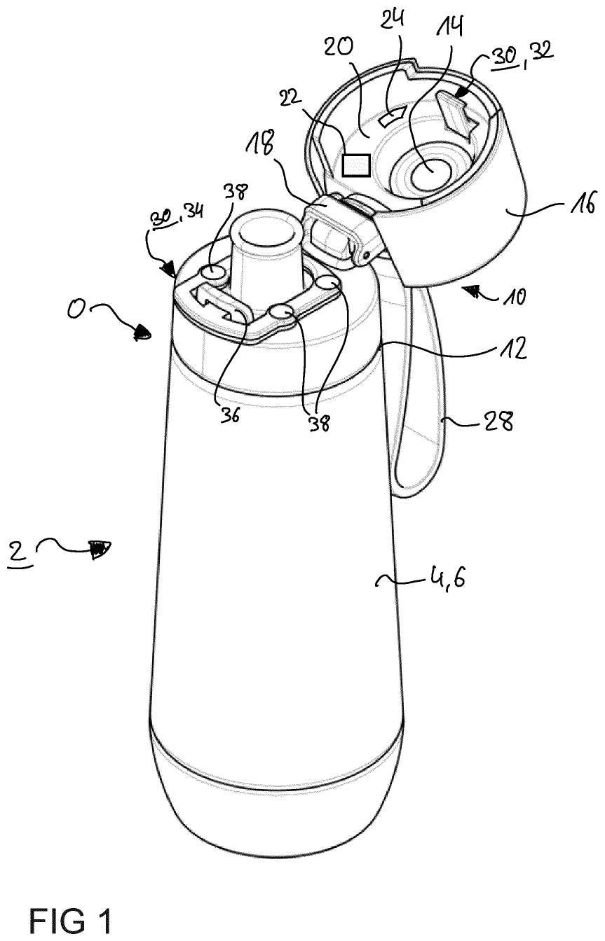

FIG. 1 shows a perspective representation of a beverage container according to the invention with the cover flap open;

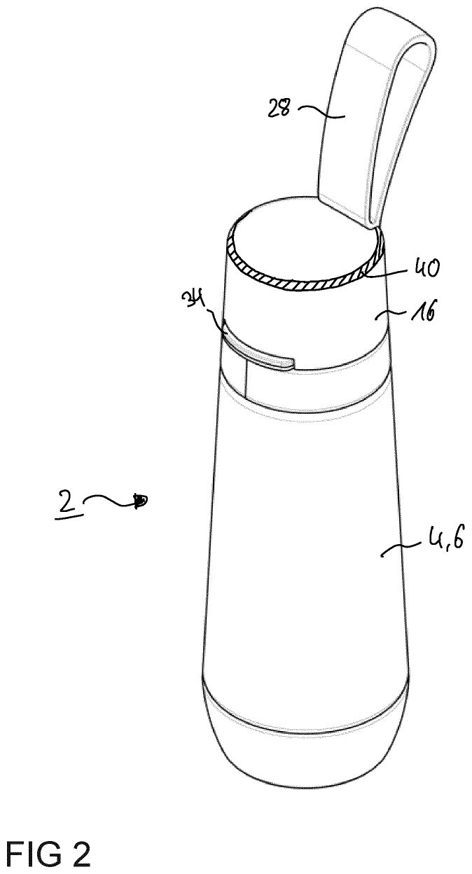

FIG. 2 shows a perspective representation of the beverage container according to the invention with the cover flap closed and

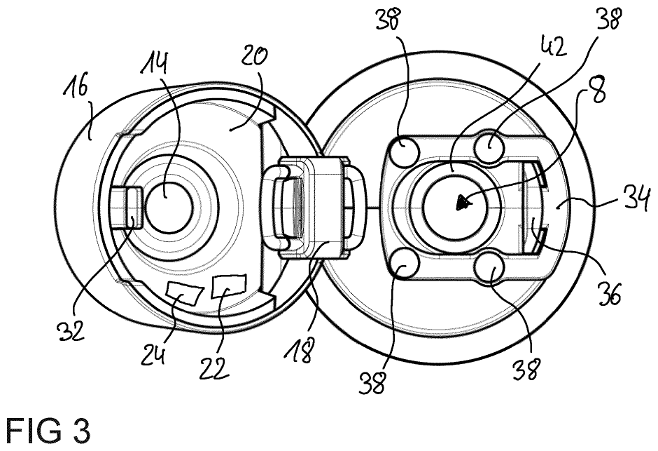

FIG. 3 shows a sketched top view of the beverage container according to the invention with the cover flap open.

In the figures, components with the same effect are always shown with the same reference numerals.

FIG. 1 shows a perspective representation of an embodiment of a beverage container 2 according to the invention. The beverage container 2 has a cup 4 with a wall 6. The wall 6 delimits a receiving space 8 (see FIG. 3) for liquid, which is open on an upper side O of the cup 4.

Further, the beverage container 2 has a cover 10 which is removably arranged on the upper side O of the cup 4 in such a manner that it closes a receiving space opening 12 (covered by arranged cover) of the receiving space 8. For example, the cover 10 is screwed onto the upper side O of the cup 4 for this purpose.

A sensor unit 14 is arranged in the cover 10 for detecting the amount of liquid removed from the cup 4 by a user.

In FIG. 1, the cover 10 is further represented in an open position. For closing and opening, i.e. transferring the cover 10 from a closed position to an open position, the cover 10 has a cover flap 16 and a folding mechanism 18, wherein the cover flap 16 is pivotably mounted on the folding mechanism 18 in order to be able to assume the aforementioned positions. In the exemplary embodiment in accordance with FIG. 1, the sensor unit 14 is arranged in the cover flap 16.

Furthermore, the cover 10 has a wireless communication unit 20. The wireless communication unit 20 is configured to form a data connection with a mobile terminal device (not shown) of the user. The wireless communication unit and the data connection designed by it also serve to transmit the detected, withdrawn amount of liquid to the user's mobile terminal device for evaluation.

In the exemplary embodiment in accordance with FIG. 1, the cover 10 also has an electric energy store 22, which for the sake of simplicity is only 20 shown as a rectangle. The electric energy store 22 is used to supply the sensor unit 14 and/or the wireless communication unit 20 with electric energy.

In order to charge the electric energy store 22, the cover 10 has a charging element 24, which is also only shown as a rectangle in this exemplary embodiment. The charging element 24 can be designed as a wireless charging element for inductive charging of the electric energy store 22. In addition or as an alternative, the cover 10 or the cup 4 may also have a charging element 24 for charging the electric energy store 22 by cable.

The beverage container 2 further comprises a carrying loop 28, which has a silicone and is particularly made of silicone.

According to the invention, the cover 10 has a locking unit 30. For its part, the locking unit 30 has a latching element 32 for locking the folding mechanism 18 and an unlocking element 34 for unlocking the latching element 32. The latching element 32 is designed as a latching tab that engages in a complementary holding tab 36 for closing the cover 10. To release this latching tab, the unlocking element 34 is moved in two axes, for example “diagonally upwards”, in order to press the latching tab out of the holding tab 36 and thus release the locking mechanism. The unlocking element 34 thus forms a threshold safety device.

To ensure a simple and reliable latching of the latching tab in the latching tab 36 during closing and that the unlocking element 34 does not hinder the formation of the latching connection, at least one pair of magnets 38, in FIG. 1 four pairs of magnets (only three visible) hold the unlocking element 34 in a locking position (position of the unlocking element 34 as represented in FIG. 1). Here, the unlocking element 34 lies flat on a surface of the cover 10.

In FIG. 2, the beverage container 2 is shown in accordance with FIG. 1, but with the cover 10 closed. This representation substantially corresponds to the figure described above, so that only the differences are referred to below in order to avoid repetition. In this view, a light element 40 designed as a LED ring can be seen, which is arranged on an upper side of the cover 10 and particularly on an upper side of the cover flap 16.

In the top view of the beverage container 2 according to the invention shown in FIG. 3 with the cover flap 16 open, the receiving space 8 of the cup 4 indicated by a mouthpiece 42 is particularly recognizable.

The invention is not limited to the exemplary embodiment described above. Rather, other variants of the invention can also be derived from this by the person skilled in art without departing from the subject matter of the invention. Particularly, all the individual features described in connection with the exemplary embodiments can furthermore be combined with one another in other ways without departing from the subject matter of the invention.

### LIST OF REFERENCE NUMBERS

2 beverage container
4 cup
6 wall
8 receiving space
10 lid
12 receiving space opening
14 sensor unit
16 lid flap
18 folding mechanism
20 wireless communication unit
22 electric energy store
24 charging element
26 wireless communication unit
28 carrying loop
30 locking unit
32 latching element
34 unlocking element
36 latching tab
38 pair of magnets
40 light element
42 mouthpiece
O upper side

1. A beverage container (2) having:
a cup (4) with a wall (6) which defines a receiving space (8) for liquid open on an upper side (O) of the cup (4), and
a cover (10), which is removably arranged on the upper side (O) of the cup (4) in such a manner that it closes a receiving space opening (12) of the receiving space (8) in a fluid-tight manner,
wherein
a sensor unit (14) is arranged in the cover (10) for detecting a quantity of liquid removed from the cup (4) by a user,
the cover (10) has a light element (40) which is configured to light up in different colors depending on the amount of liquid removed by the user and
the cover (10) further has a wireless communication unit (20) which is configured to form a data connection with a mobile terminal device of the user and to transmit the detected quantity of liquid to the mobile terminal device of the user for evaluation.

2. A beverage cup (2) according to claim 1
wherein the sensor unit (14) is further configured to detect organic pollutants, particularly bacteria and/or viruses in the saliva of the user and/or at least one vital value derivable from the saliva of the user.

3. The beverage container (2) according to claim 1 or 2,
wherein the cup (4) and/or the cover (10) has/have an electric energy store (22).

4. The beverage container (2) according to claim 3,
wherein the cup (4) and/or the cover (10) has/have a charging element (24) for wired and/or wireless charging of the electric energy store (22).

5. The beverage container (2) according to any of the preceding claims,
wherein the sensor unit (14) is arranged in the cover (10).

6. The beverage container (2) according to any of the preceding claims, wherein the light element (40) is designed as a light ring, particularly as a LED light ring, which is arranged on an upper side of the cover (10).

7. The beverage container (2) according to any of the preceding claims,
wherein the cover (10) has a cover flap (16) and a folding mechanism (18) on which the cover flap (16) is pivotably mounted from a closed position to an open position and vice versa.

8. The beverage container (2) according to claim 7,
wherein the cover (10) has a locking unit (30) for locking the folding mechanism (18), which has a latching element (32) for locking the folding mechanism (18) and an unlocking element (34) for unlocking the latching element (32).

9. The beverage container (2) according to claim 8,
wherein the unlocking element (34) is held in a locking position by means of at least one pair of magnets (38).

10. The beverage container (2) according to any of claims 7 to 9,
wherein the folding mechanism (18) and the wireless communication unit (20) are designed to form the data connection with the mobile terminal device when the cover flap (16) is pivoted from the closed position to the open position.

11. The beverage container (2) according to any of the preceding claims,
wherein the sensor unit (14) has a turbine sensor or a laser sensor or an ultrasonic sensor for detecting the amount of liquid removed.

12. The beverage container (2) according to any of the preceding claims,
wherein the cup (4) and/or the cover (10) has/have a plastic material.

13. The beverage container (2) according to any of the preceding claims,
wherein the receiving space (8) has a volume with a value in the area of 0.2 l to 1.5 l, preferably in the area of 0.5 l to 1 l and particularly with a value of 0.75 l.

14. The beverage container (2) according to any of the preceding claims, wherein a carrying loop (28) is arranged on the cover (10).
